(19) United States
(12) Patent Application Publication
(10) Pub. No.: US 2018/0054016 A1
(43) Pub. Date: Feb. 22, 2018

(54) ELECTRICAL CONNECTOR CARD TRAY HAVING A FRAME AND A COVER DETACHABLY MOUNTED TO THE FRAME

(71) Applicant: FOXCONN INTERCONNECT TECHNOLOGY LIMITED, Grand Cayman (KY)

(72) Inventor: XIAO-BO SUO, Shenzhen (CN)

(21) Appl. No.: 15/680,232

(22) Filed: Aug. 18, 2017

(30) Foreign Application Priority Data
Aug. 18, 2016 (CN) 201610679725.7

(51) Int. Cl. H01R 13/447; H01R 12/71

(52) U.S. Cl. CPC H01R 13/447; H01R 12/71

(57) ABSTRACT

A card tray (100) includes: a frame (1) having a seating portion (13); and a cover (2) detachably mounted to the frame, the cover and the frame confining a space for an electronic card. The cover may include a main body (21) engaging a top of the frame and plural fingers (211/212/214) engaging a bottom of the frame.

### BACKGROUND OF THE INVENTION

### 1. Field of the Invention

The present invention relates to a card tray for a card connector and more particularly to a card tray having a detachable cover to positively confine an inserted electronic card in the card tray.

### 2. Description of Related Arts

China Patent No. 203071270 discloses a card tray having a frame and a hand-gripping or face plate portion. The frame has a bottom plate portion for seating an electronic card. The card tray is to be inserted into a card connector.

U.S. Patent Application Publication No. 2014/0113495 discloses a card tray having a main body and a hand-gripping portion. The main body has a lateral side opening for inserting an electronic card, a spacer for seating the inserted electronic card, and a supporting plate positioned at an opposing side of the opening for limiting displacement of the inserted electronic card. The side opening and related structure may be replaced by a guide slope surface and associated structure.

WO 2017/039872 discloses a card connector including a base and a shielding tray that can be detachably connected to the base. The shielding tray has a fixing portion operable to fix an electronic card in a fixed position within the shielding tray. A flat portion may be arranged on the shielding tray so that the card can be laid against the flat portion upon having been installed to the shielding tray. Surrounding portions may be arranged on the shielding tray and the fixing portion may be provided on the surrounding portions. The surrounding portions can be implemented as a wall perpendicular to the flat portion.

A card tray of a different construction is desired.

### SUMMARY OF THE INVENTION

A card tray comprises: a frame having a seating portion; and a cover detachably mounted to the frame, the cover and the frame confining a space for an electronic card. Inadvertent falling of an electronic card off the frame during connecting/disconnecting the card tray to/from an electrical connector is prevented.

### BRIEF DESCRIPTION OF THE DRAWING

FIG. 1 is an assembled perspective view of a card tray in accordance with the present invention;

FIG. 2 is another perspective view of the card tray;

FIG. 3 is a perspective view of the card tray with a cover thereof detached and a frame thereof loaded with electronic cards;

FIG. 4 is a view similar to FIG. 3 but with the electronic cards removed;

FIG. 5 is another perspective view of FIG. 4;

FIG. 6 is another perspective view of the frame;

FIG. 7 is a perspective view of the frame loaded with electronic cards;

FIG. 8 is another perspective view of the cover; and

FIG. 9 is a cross-sectional view of the card tray taken along line A-A in FIG. 1.

### DETAILED DESCRIPTION OF THE PREFERRED EMBODIMENT

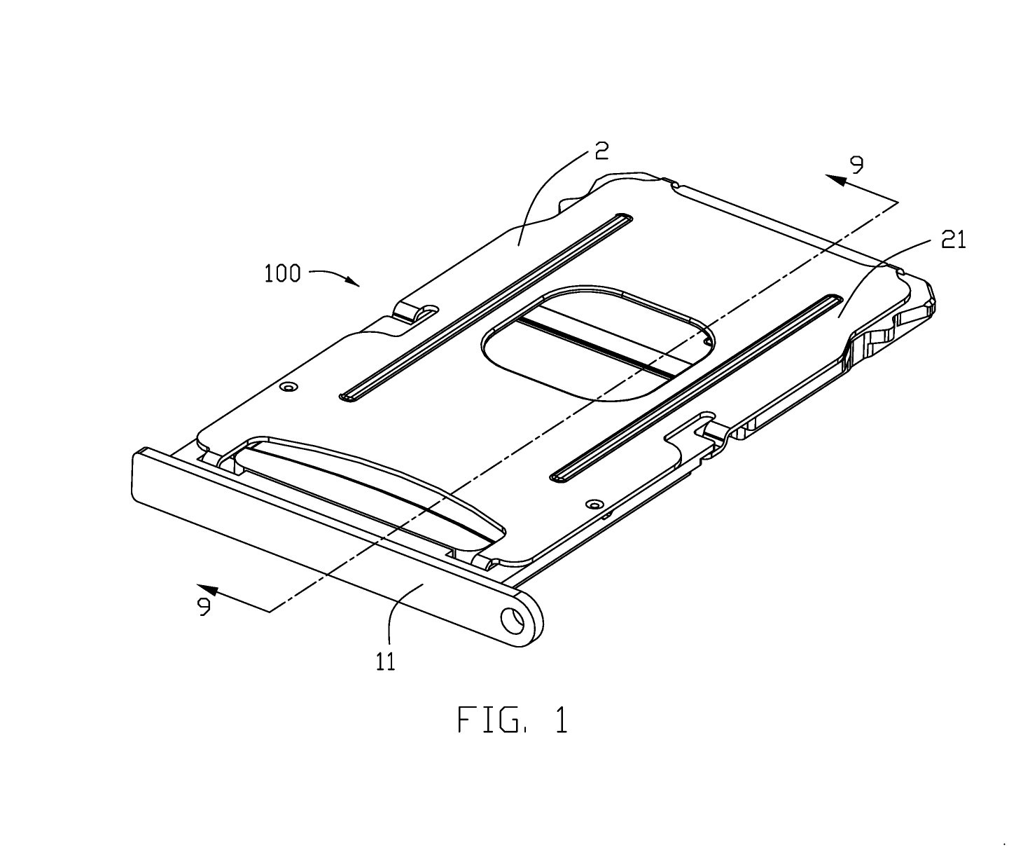

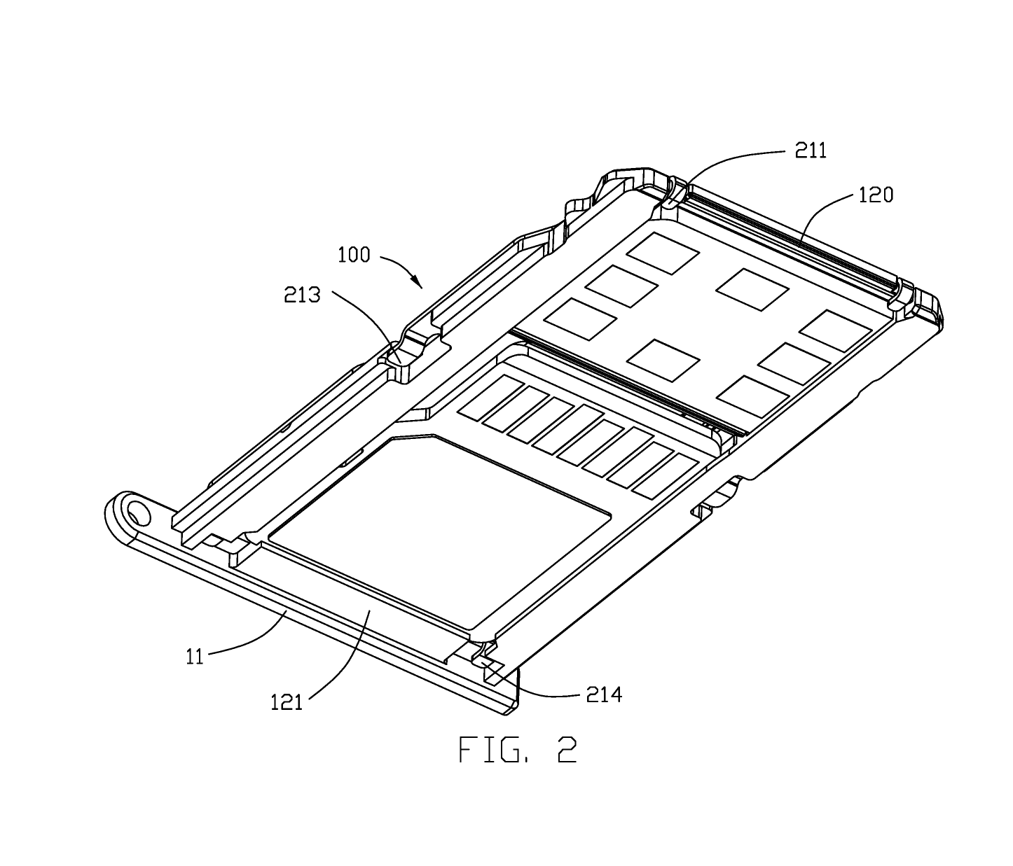

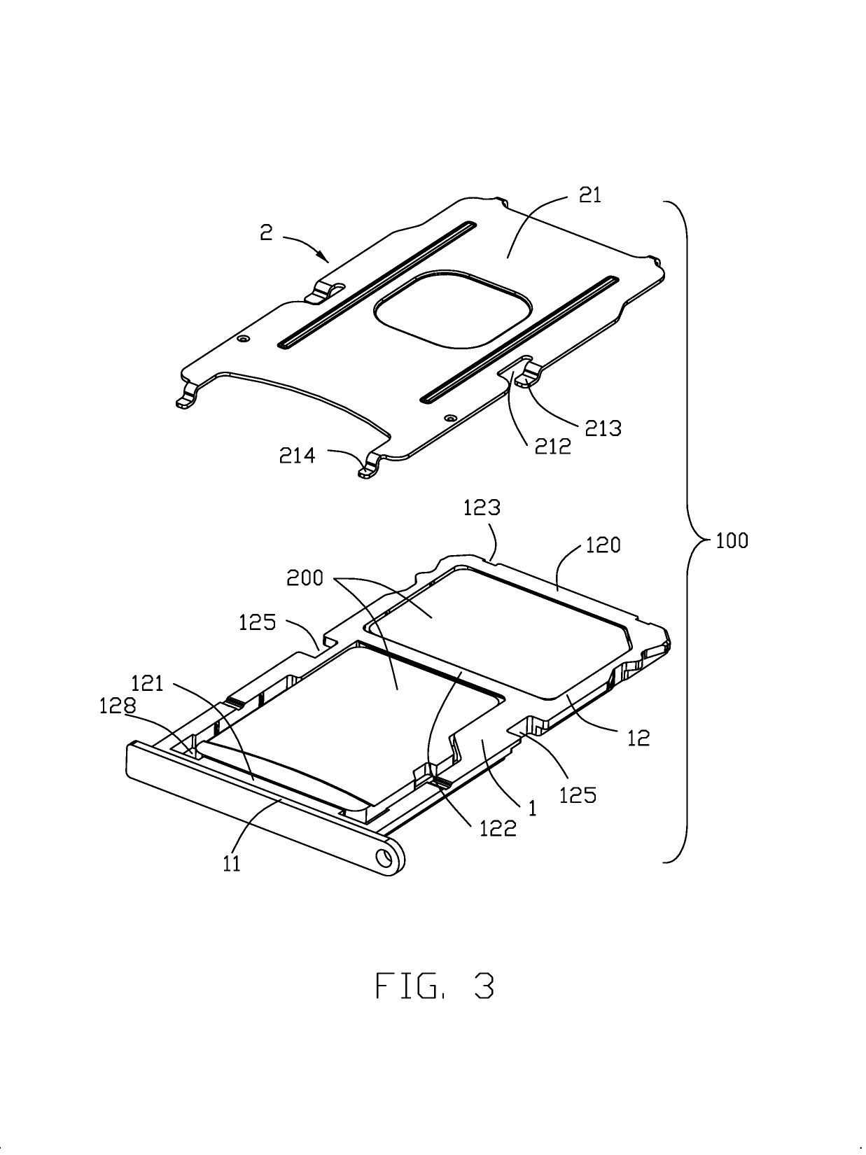

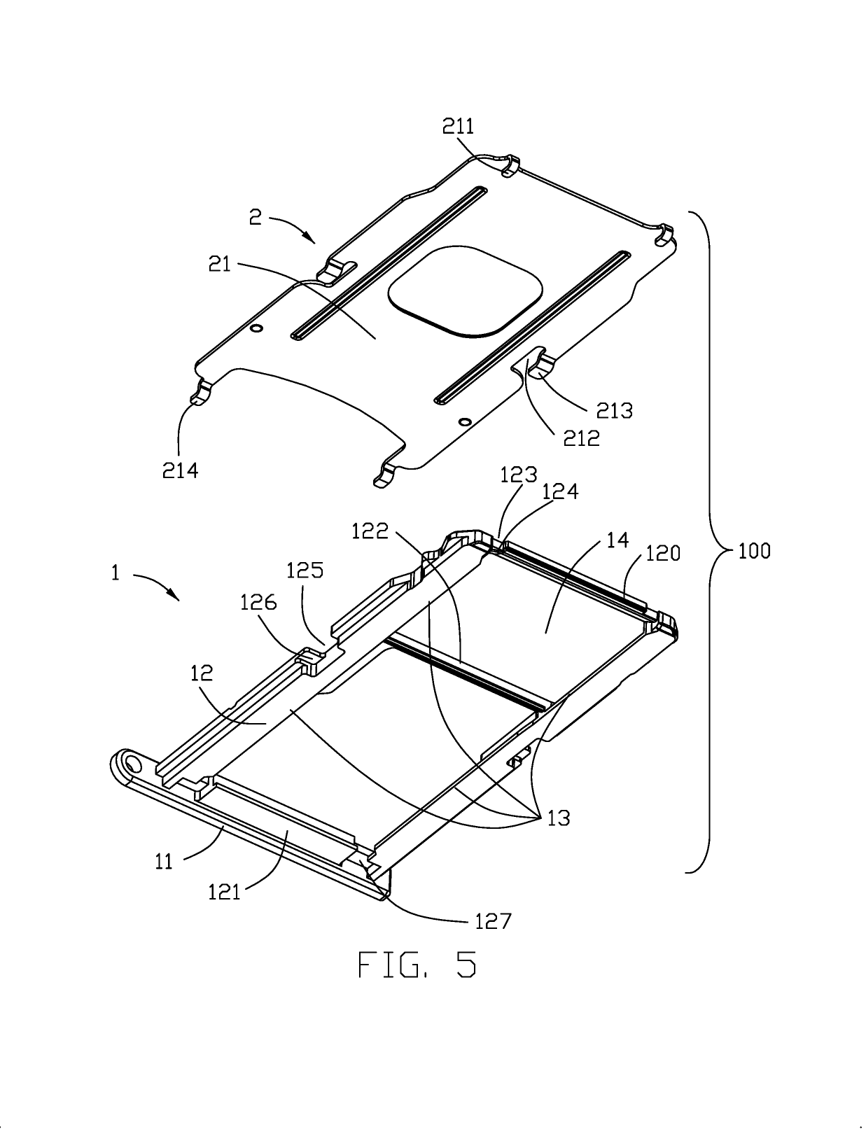

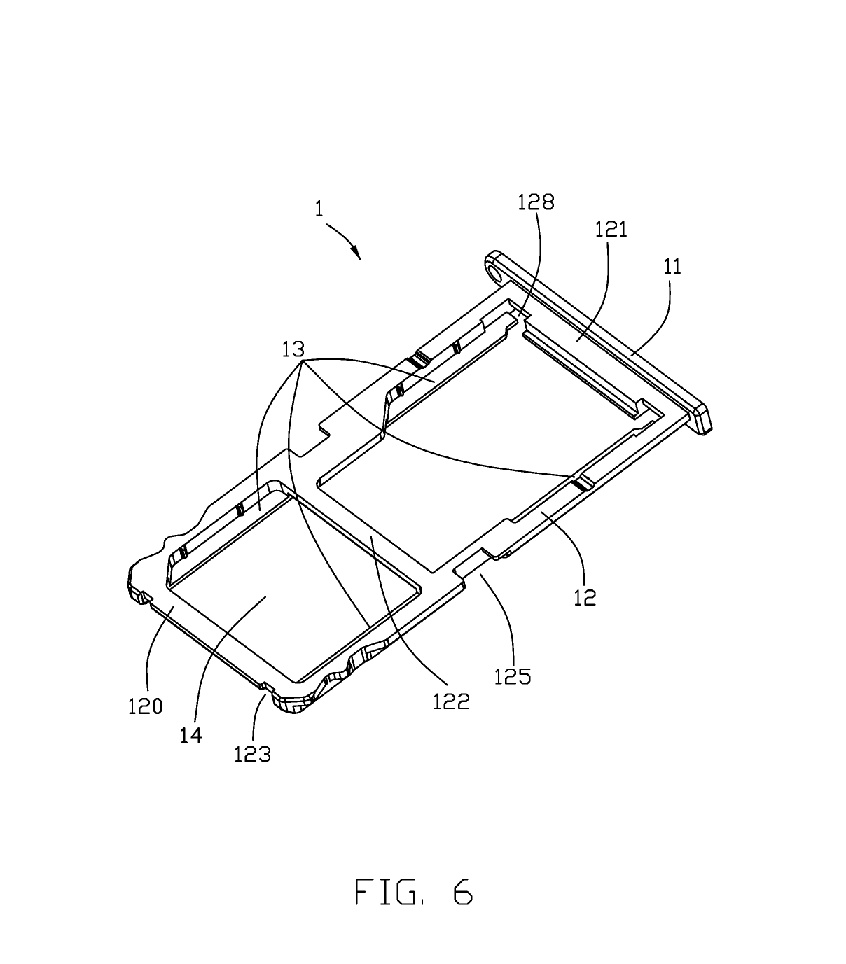

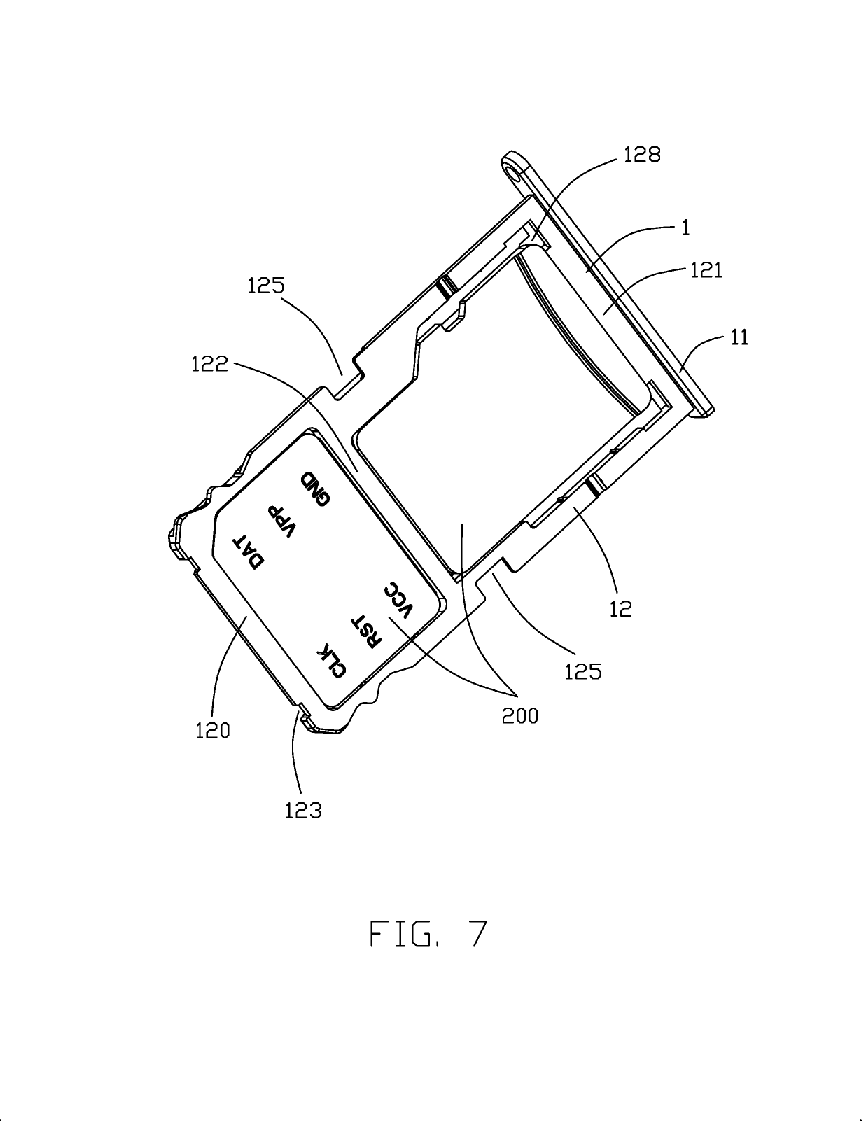

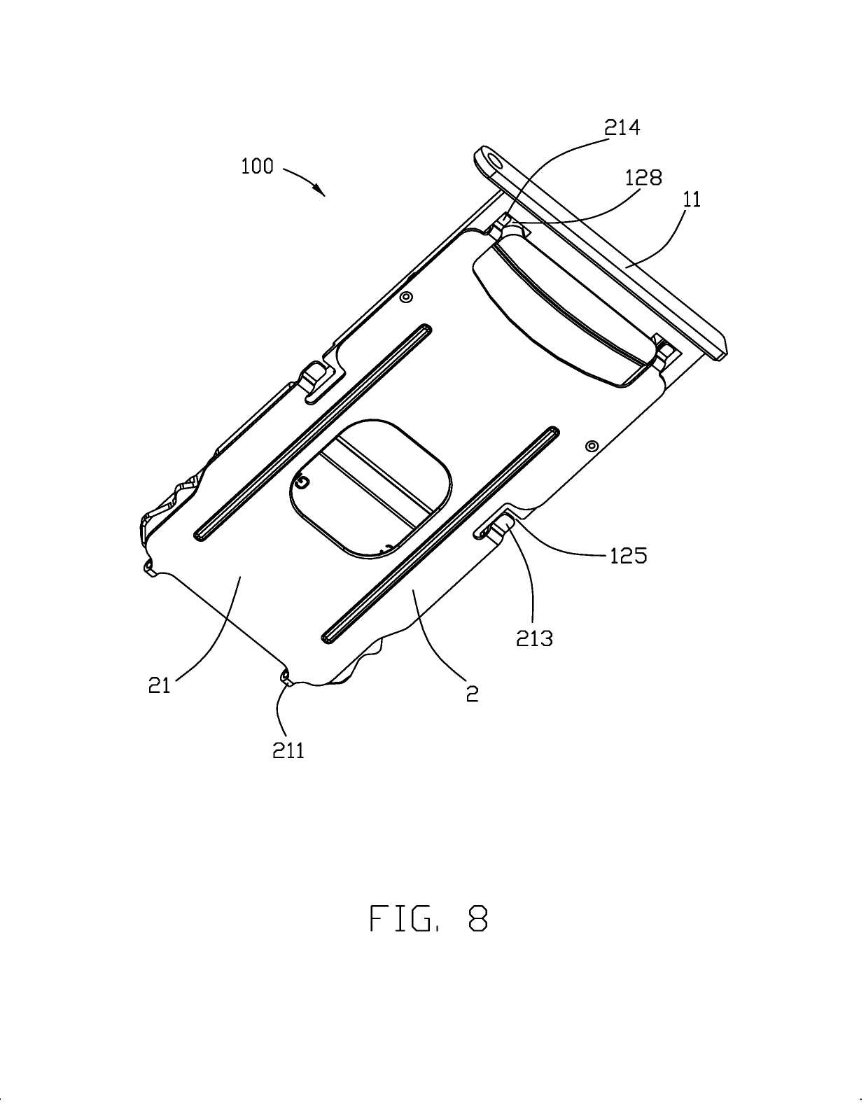

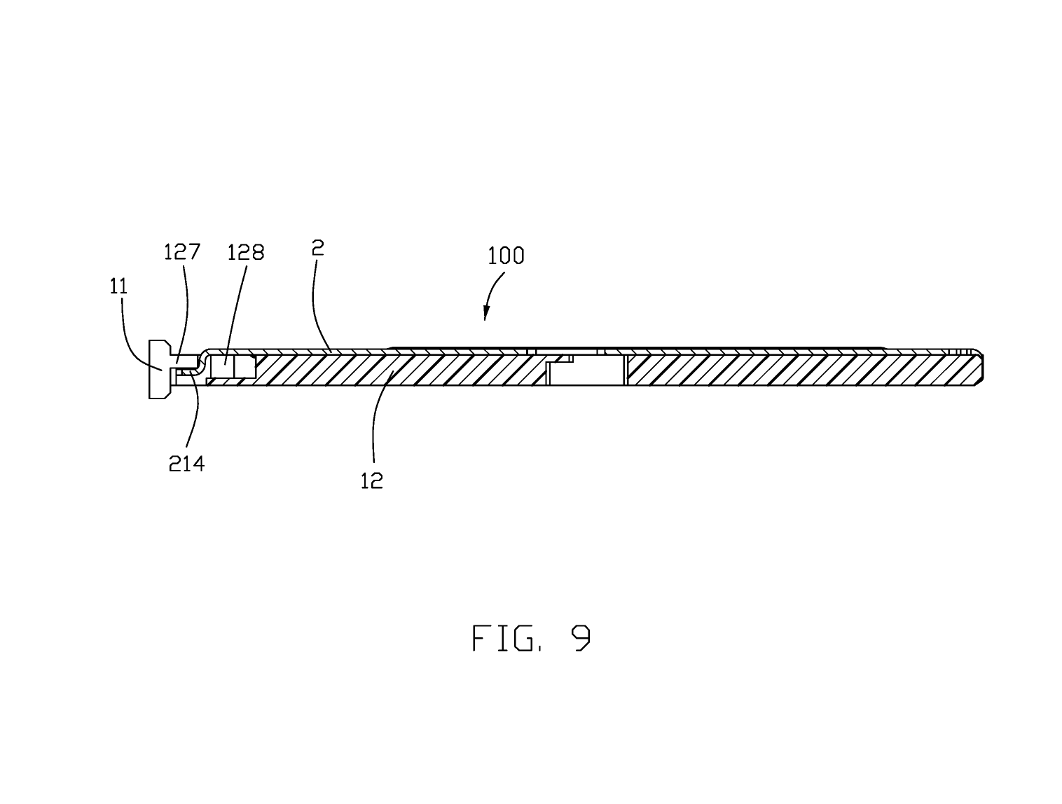

Referring to FIGS. 1-9 in general, and particularly to FIG. 3, a card tray 100 for accommodating one or more electronic cards 200 is to be connected to an electrical connector in an electronic device. The card tray 100 includes a frame 1 and a cover 2 to be detachably mounted to the frame 1.

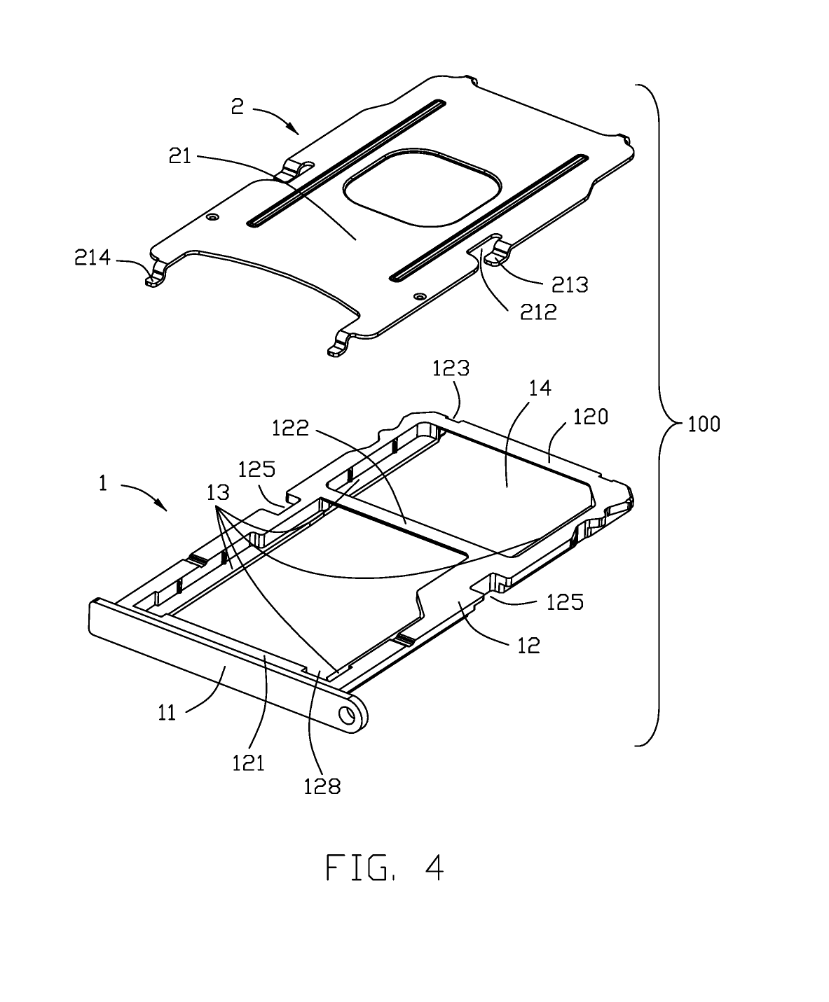

Referring to FIGS. 4-6, the frame 1 is made of stainless steel, aluminum alloy, or the like metallic material. The frame 1 includes a main body 12 and a front face plate 11. The main body 12 has a receiving space 14 opening upward for accommodating an electronic card 200.

The main body 12 includes a first cross beam 120, a second cross beam 121, and a middle cross beam 122. The middle cross beam 122 divides the space 14 into two parts. The main body 12 also includes a seating portion 13 for holding an inserted electronic card 200. The first cross beam 120 has a pair of first through holes 123 and a pair of first abutments 124 beside the through holes 123. Two sides of the main body 12 has a pair of second through holes 125 and a pair of second abutments 126 beside the through holes 125. The second cross beam 121 has a pair of third through holes 128 and a pair of third abutments 127 beside the through holes 128. The third through holes 128 are in fluid communication with the space 14.

The cover 2 is made of stainless steel. The cover 2 includes a main body 21, a pair of first fingers 211 bent from one end of the main body 21, a pair of second fingers 213 at two sides of the main body 21, and a pair of third fingers 214 bent from the other end of the main body 21. A slot 212 is formed beside the second finger 213.

In use, an electronic card 200 is received in the same 14 and seated upon the seating portion 13 and the cover 2 is attached to the frame 1. Namely, first the first fingers 211 extend through the first through holes 123, the second fingers 213 extend through the second through holes 125, and the third fingers 214 extend through the third through holes 128. Then the cover 2 slides relative to the frame 1 so that the first fingers 211 engage the first abutments 124, the second fingers 213 engage the second abutments 126, and the third fingers 214 engage the third abutments 127. Therefore, the main body 21 engages a top of the frame 1 and the fingers 211, 213, and 214 engage a bottom of the frame 1 with the electronic card 200 positively confined in the space 14.

The cover 2 is detachable from the frame 1 by a sliding movement in a reverse direction to disengage the fingers 211, 213, and 214 from the abutments 124, 126, and 127, respectively.

Provision of a detachable cover 2 ensures that inadvertent falling of an electronic card off the frame 1 during connecting/disconnecting the card tray 100 to/from an electrical connector is prevented.

Notably, because the card tray is essentially an closed manner to efficiently hold the electronic card therein without withdrawal risk, the user may easily align the card tray with the corresponding opening of the portable device for installing the electronic card advantageously. On the contrary, in some traditional designs, the cellular phone may need to be put in an upside down horizontal manner for changing the electronic card because the orientation limitation of the card tray with regard to the corresponding connector in the cellular phone.

What is claimed is:

1. A card tray comprising:
a frame having a seating portion; and
a cover detachably mounted to the frame, the cover and the frame confining a space for an electronic card.

2. The card tray as claimed in claim 1, wherein the cover includes a main body engaging a top of the frame and a plurality of fingers engaging a bottom of the frame.

3. The card tray as claimed in claim 1, wherein the frame includes a main body and a face plate, and the cover has a main body, a width of the frame main body being substantially equal to a width of the cover main body.

4. The card tray as claimed in claim 1, wherein the frame is metallic.

5. The card tray as claimed in claim 1, wherein the cover is metallic.

6. A card tray for use with an electronic card, comprising:
a frame having a seating portion which has an upward face for upwardly supporting the electronic card and defines an opening to downwardly expose conductive pads of the electronic card in a vertical direction; and
a cover detachably mounted to the frame to cover at least a portion of said upward face; wherein
a space is defined between the cover and the frame for snugly receiving said electronic card both vertically and horizontally.

7. The card tray as claimed in claim 6, wherein said cover is dimension large enough for prohibiting the electronic card from being dropped from the card tray.

8. The card tray as claimed in claim 6, wherein said frame is configured to leave space allowing fingers of the cover to be received therein initially in said vertical direction and successively to be moved in a horizontal direction for engagement with the frame so as to prevent withdrawal of the cover from the frame in the vertical direction.

9. An electrical card tray assembly comprising:
a frame having a seating portion which has an upward face for upwardly supporting the electronic card and defines an opening to downwardly expose conductive pads of the electronic card in a vertical direction; and
a cover detachably mounted to the frame to form a card tray and to cover at least a portion of said upward face; wherein
an electronic card is vertically and horizontally snugly received in a space formed between the cover and the frame without withdrawal risk from the card tray before the card tray is inserted into a portable device.

10. The card tray as claimed in claim 9, wherein said cover is dimension large enough for prohibiting the electronic card from being dropped from the card tray.

11. The card tray as claimed in claim 9, wherein said frame is configured to leave space allowing fingers of the cover to be received therein initially in said vertical direction and successively to be moved in a horizontal direction for engagement with the frame so as to prevent withdrawal of the cover from the frame in the vertical direction.
